(19) United States
(12) Patent Application Publication
(10) Pub. No.: US 2021/0140112 A1
(43) Pub. Date: May 13, 2021

(54) WATER SOLUBLE DYE COMPOSITIONS

(71) Applicant: CHROMASCAPE, LLC, Twinsburg, OH (US)

(72) Inventors: LEONIDAS KYRIAZIS, GREENVILLE, SC (US); JOSEPH F. LYNCH, NEW BRUNSWICK, NJ (US); PETER T. LYNCH, NEW BRUNSWICK, NJ (US); PETER J. RUMORE, NEW BRUNSWICK, NJ (US); THOMAS J. MCALPINE, GREENVILLE, SC (US)

(21) Appl. No.: 17/096,267

(22) Filed: Nov. 12, 2020

Related U.S. Application Data
(60) Provisional application No. 62/934,765, filed on Nov. 13, 2019.

(51) Int. Cl. D21H 21/28; D21H 21/30; D21H 17/03; D21H 17/25; D21H 17/66

(52) U.S. Cl. CPC D21H 21/28; D21H 21/30; D21H 17/66; D21H 17/25; D21H 17/03

(57) ABSTRACT

Provided herein is a colorant composition comprising: 1) water; 2) at least one water-soluble inorganic salt; 3) microcrystalline cellulose; and 4) at least one colorant comprising water-soluble anionic dyes, water-soluble fluorescent brighteners, water-soluble cationic dyes, or combinations thereof. The colorant composition described may have a weight ratio of the at least one water-soluble inorganic salt to the at least one colorant in the colorant composition ranges from 1:0.25 to 1:4.0 and a specific gravity of the colorant composition is about 1.05 kg/l to about 1.45 kg/l. Also provided are methods of preparing the disclosed colorant composition.

The present application claims the benefit of U.S. Provisional Patent Application No. 62/934,765 filed Nov. 13, 2019, which is incorporated herein by reference in its entirety.

### FIELD

The present disclosure relates generally to colorant compositions, namely water-soluble colorant compositions, particularly useful for liquid addition to various products, including but not limited to building and construction materials, landscaping materials, foods, plastics, paper, textiles, yarns, finer, leather, wood, printing inks, and paints and coatings. The present disclosure also relates to methods of making the colorant compositions described herein.

### BACKGROUND

Colorants are routinely used in many products as dyes or pigments. Unlike water-insoluble pigments, dyes are water-soluble colorants that may be a more environmentally friendly choice for many products. These water-soluble colorants may include those identified as acid dyes, direct dyes, reactive dyes, and cationic dyes as defined by the Color Index™ as published by the Society of Dyers and Colourists (SDC) and American Association of Textile Chemists and Colourists (AATCC). The water-soluble colorants are classified under each of these classes and may be characterized by having a measureable water solubility defined in g/l values.

In order to provide a consistent color standard when evaluated for color saturation (color saturation refers to the intensity of a color) and color lightness/darkness (color lightness/darkness refers to the lightness or darkness of a color indicating the quantity of light reflected), water-soluble colorants are measured relative to an industry or product standard. Color value, as described herein, refers to both the color saturation and color lightness/darkness of a measured color with respect to an industry or product standard.

Water-soluble colorants are conventionally marketed in powder, granular and liquid forms. To prepare the powder and granular form, the dye crude (referring to a dye directly obtained from the synthesis product) may be used. The dye crude may be mixed with non-colorant materials, including but not limited to soluble fillers or standardizing agents, coagulating agents, wetting agents, dedusting oils and solubilizing aids, to obtain a particular colorant industry or product standard color value. Other non-colorant materials may also provide storage stability or dyeing/color fastness properties. However, the use of some of the non-colorant materials in the powder and granular forms may result in additional waste streams requiring special treatment before release to the environment. Further, any powder forms of water-soluble colorants may create a hygiene problems associated with handling and dusting issues. Granular forms are designed to alleviate the dust problems of the powders. However, the granular forms may degrade over time and form dusty materials during storage or handling.

To avoid the problems associated with the handling of the powder and granular forms, many water-soluble colorants are marketed in liquid form as aqueous solutions. High packaging and transportation costs may be incurred due to the liquid nature of the colorant, but the benefits of using a liquid form may outweigh these additional costs. However, due to the limited water solubility of the colorants, the color strength (meaning the value of the aqueous solutions tends to be lower than desired with water-soluble colorants. Therefore, conventionally, water-soluble colorants provided in liquid form may include water miscible solvents to improve solubility and enhance the color content of the water-soluble colorant. Typically, in color value as measured relative to an industry or customer standard using transmission or reflectance spectrophotometers, powder and granular forms may be marketed at 200% (twice the color value of the standard) or 100% (equal color value to the standard). In contrast, the measured color of the liquid dye products may range from 25% to 67% of these standards, with around 50% being the most common. Additionally, the solvents and/or solubilizing agents added to the liquid colorant formulation may require special waste treatment or significantly higher waste costs if any waste must be sent to municipal treatment systems. Further, these solvents and/or solubilizing agents in the liquid colorants may increase the volatile organic compounds (VOC's) content of the liquid colorants, which may limit their product use and/or geographical distribution. Volatile organic compounds (VOC) means (according to EPA 40 CFR Part 51.100(s)) any compound of carbon, excluding carbon monoxide, carbon dioxide, carbonic acid, metallic carbides or carbonates, and ammonium carbonate, which participates in atmospheric photochemical reactions.

Although using liquid colorants avoids the dusting issues associated with powder or granular colorants, there may be other handling issues such as pumpability through metering systems. Further, the liquid colorants may suffer from storage stability issues like temperature fluctuations and dye precipitation, thus leading to quality issues. In addition, liquid colorants may require storage at controlled temperature to avoid freezing the liquid colorant or to avoid crystallization of the colorant from the liquid portion.

In view of these challenges with the use of conventional liquid colorants, the need therefore remains for improved color value, decreased VOC's, improved pumpability, and minimized handling and storage stability issues, as well as other advantages. There is also a need for a method to prepare such dye compositions.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

Colorant compositions and methods of making the provided colorant compositions may be shown and described. In many embodiments, the disclosure is to a colorant composition comprising: 1) water; 2) at least one water-soluble inorganic salt; 3) microcrystalline cellulose; and 4) at least one colorant comprising water-soluble anionic dyes, water-soluble fluorescent brighteners, water-soluble cationic dyes, or combinations thereof. The colorant composition described may have a weight ratio of the at least one water-soluble inorganic salt to the at least one colorant in the colorant composition ranges from 1:0.25 to 1:4.0 and a specific gravity of the colorant composition is about 1.05 kg/l to about 1.45 kg/l.

In some embodiments, the at least one water-soluble inorganic salt comprises lithium chloride, potassium chloride, sodium chloride, calcium chloride, or combinations thereof. In many embodiments, the at least one water-soluble inorganic salt comprises about 5% by weight to about 27% by weight of the colorant composition. In many embodiments, the microcrystalline cellulose comprises about 0.2% by weight to about 5.0% by weight of the colorant composition.

In many embodiments, the at least one colorant is an acid dye, a direct dye, a reactive dye, or combinations thereof. In one embodiment, the at least one colorant is a water-soluble anionic dye. In one embodiment, the at least one colorant is a water-soluble fluorescent brighteners. In one embodiment, the at least one colorant is a water-soluble cationic dye. In many embodiments, the at least one colorant comprises about 10% by weight to about 50% by weight of the colorant composition.

In many embodiments, the colorant composition is a dye. In some embodiments, the dye is used to color textile, yarn, fiber, paper, leather, wood, plastic, ink, food, or combinations thereof.

In some embodiments, the colorant composition further comprises at least one defoaming agent, humectant, dispersant, surfactant, binder, biocide, fungicide, mildewcide, or combinations thereof.

Also provided are methods of preparing the disclosed colorant composition. In many embodiments, a method of preparing a colorant composition comprises: 1) preparing a mixture of water and microcrystalline cellulose, wherein the mixture comprises about 0.2% by weight to 5.0% by weight microcrystalline cellulose; 2) adding at least one water-soluble inorganic salt to the mixture of water and microcrystalline cellulose; and 3) adding at least one colorant comprising water-soluble anionic dyes, water-soluble fluorescent brighteners, water-soluble cationic dyes, or combinations thereof to the mixture of water, microcrystalline cellulose, and at least one water-soluble inorganic salt. In some embodiments, the colorant composition described herein further comprises adjusting a specific gravity of the colorant composition, adjusting a viscosity of the colorant composition, adjusting a pH of the colorant composition, or combinations thereof by providing additional water, at least one water-soluble inorganic salt, at least one colorant, or combinations thereof.

### DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure generally relates to colorant compositions, namely water-soluble colorant compositions, that, when used for various products, provide advantageous improvements over current colorants. These improvements for the colorant composition described herein may include improved color value, decreased VOC's, improved pumpability, and minimized handling and storage stability issues, as well as other advantages. It would be beneficial for a colorant composition to provide storage stability with respect to settling, dye crystallization, and microbial degradation. It would also be desirable for a colorant composition to contain no or minimal chemicals which require special handling. Further, it would be beneficial for a colorant composition to be environmentally-friendly and have a neutral environmental impact by using materials that do not require specialized waste streams as well as decreased or no VOC's compared to current water-soluble liquid colorants. For example, it would be beneficial to minimize or eliminate any use of urea, triethylamine (TEA), and diethylamine (DEA). It would also be desirable if the colorant compositions have limited solvent content or are substantially solvent-free. Additionally, it would be beneficial if the colorant compositions were pumpable and meterable.

There are challenges associated with balancing the above needs for a colorant composition to meet requirements for acceptable water-soluble colorants. These requirements include storage stability, color value, no or minimal handling issues, and environmentally friendly products. As noted above, many water-soluble colorant compositions often result in issues in trying to meet these requirements. It has been found difficult for a colorant composition to simultaneously address all of these requirements.

Disclosed herein are certain colorant compositions that beneficially provide for these requirements provided above. The colorant compositions described are water-soluble colorant compositions. In many embodiments, a colorant composition comprises: 1) water; 2) at least one water-soluble inorganic salt; 3) microcrystalline cellulose; and 4) at least one colorant comprising water-soluble anionic dyes, water-soluble fluorescent brighteners, water-soluble cationic dyes, or combinations thereof. For typical water-soluble colorants, the dissolution of a dye may be provided through the selection of solvents, solubilizing agents, and other materials. Although not bound by theory, the colorant composition described herein may provide a composition wherein the water-soluble colorant may be in the form of solid particles made at least partially insoluble by a high electrolyte content of the colorant composition. By providing the high electrolyte content, the colorant composition may provide improved storage stability, improved color value, no or minimal handling issues, and environmentally friendly products.

In many embodiments, the colorant composition described has a weight ratio of the at least one water-soluble inorganic salt to the at least one colorant in the colorant composition ranges from 1:0.25 to 1:4.0. In further embodiments, the colorant composition described has a weight ratio of the at least one water-soluble inorganic salt to the at least one colorant in the colorant composition can, for example, range from 1.0:0.5 to 1:4.0, e.g., from 1.0:0.25 to 1:3.0, from 1.0:0.5 to 1:3.0, from 1.0:0.7 to 1:4.0, from 1.0:0.8 to 1:4.0, from 1.0:1.0 to 1:4.0, from 1.0:1.2 to 1:4.0, from 1.0:1.5 to 1:4.0, from 1.0:1.7 to 1:4.0, from 1.0:2.0 to 1:4.0, from 1.0:2.2 to 1:4.0, from 1.0:2.5 to 1:4.0, from 1.0:2.8 to 1:4.0, from 1.0:3.0 to 1:4.0, or from 1.0:3.5 to 1:4.0. Other ratios are also contemplated.

In many embodiments, the colorant composition described has a specific gravity that can, for example, range from about 1.05 kg/l to about 1.45 kg/l. Specific gravity can be measured by filling and weighing a specific gravity cup at room temperature (20° C.). In further embodiments, the colorant composition described has a specific gravity of about 1.10 kg/l to about 1.45 kg/l, e.g., from about 1.15 kg/l to about 1.45 kg/l, from about 1.20 kg/l to about 1.45 kg/l, from about 1.25 kg/l to about 1.45 kg/l, from about 1.30 kg/l to about 1.45 kg/l, from about 1.35 kg/l to about 1.45 kg/l, from about 1.05 kg/l to about 1.40 kg/l, from about 1.05 kg/l to about 1.30 kg/l, from about 1.10 kg/l to about 1.35 kg/l, and from about 1.15 kg/l to about 1.45 kg/l. Other specific gravities are also contemplated.

In many embodiments, the water in the disclosed colorant composition comprises about 30% by weight to about 75% by weight of the colorant composition. In other embodiments, the water may be about 40% by weight to about 70% by weight of the colorant composition. In another embodiment, the water may be about 45% by weight to about 65% by weight of the colorant composition.

In many embodiments, the at least one water-soluble inorganic salt in the colorant composition comprises lithium chloride, potassium chloride, sodium chloride, calcium chloride, or combinations thereof. In many embodiments, the water-soluble inorganic salt may be any alkali metal halide or alkaline earth metal halide that is compatible with the colorant composition and imparts no toxicity or environmental hazard. In many embodiments, halide salts may include, but are not limited to, fluorides, chlorides, bromides, iodides, and combinations thereof. In some embodiments, chlorides of the halide salts may comprise lithium chloride, sodium chloride, potassium chloride, calcium chloride, and combinations thereof. Other salts may also be contemplated. In many embodiments, the at least one water-soluble inorganic salt comprises about 5% by weight to about 27% by weight of the colorant composition. In some embodiments, the at least one water-soluble inorganic salt comprises about 5% by weight to about 25% by weight of the colorant composition. In other embodiments, the at least one water-soluble inorganic salt comprises about 10% by weight to about 25% by weight of the colorant composition. In still other embodiments, the at least one water-soluble inorganic salt comprises about 10% by weight to about 20% by weight of the colorant composition. In yet other embodiments, the at least one water-soluble inorganic salt comprises about 15% by weight to about 25% by weight of the colorant composition.

In many embodiments, the microcrystalline cellulose comprises about 0.2% by weight to about 5.0% by weight of the colorant composition. In other embodiments, the microcrystalline cellulose comprises about 0.5% by weight to about 5.0% by weight of the colorant composition. In some embodiments, the microcrystalline cellulose comprises about 1.0% by weight to about 5.0% by weight of the colorant composition. In another embodiment, the microcrystalline cellulose comprises about 1.0% by weight to about 4.0% by weight of the colorant composition. In yet another embodiment, the microcrystalline cellulose comprises about 1.0% by weight to about 3.0% by weight of the colorant composition. In still another embodiment, the microcrystalline cellulose comprises about 1.0% by weight to about 2.0% by weight of the colorant composition. In many embodiments, microcrystalline cellulose may be a refined wood pulp. Although not bound by theory, microcrystalline cellulose may form a three dimensional structural network or gel form to the colorant composition described herein due to its fibril structure forms. In many embodiments, microcrystalline cellulose has substantial compatibility with the colorant composition, particularly with the high electrolyte content of the colorant composition. In many embodiments, the microcrystalline cellulose may act as a thickening agent. Although not to be bound by theory, the combination of the high electrolyte content of the colorant composition and the thickening action of the microcrystalline cellulose may imparts thixotropic or pseudoplastic properties to the colorant composition wherein the high viscosity and specific gravity of the composition stabilizes the suspension of the dye particles. Due to this thixotropic or pseudoplastic nature of the composition, the colorant composition may become fluid when subjected to low sheer mixing and can be metered through a pumping system to the dye application unit.

In many embodiments, the at least one colorant of the colorant composition is an acid dye, a direct dye, a reactive dye, or combinations thereof. In many embodiments, water-soluble dyes anionic dyes may include any of acid, direct and reactive dyes as defined by the Colour Index™ from the Society of Dyers and Colorants. These dyes may contain functional groups that carry an active hydrogen that is released under neutral and alkaline pH to form an anionic group that may impart at least some degree of water solubility to the dye. Such groups include but are not limited to sulfonic acids, carboxylic acids, phosphonic acids, and combinations thereof. As dyes are conventionally characterized in relation to a color strength standard, the water solubility may be defined as from 1 g/l to 250 g/l as 100% color equivalent to the standard.

In many embodiments, the water-soluble anionic dyes of the disclosed colorant composition comprise C.I. acid red 361, C.I. acid red 151, C.I. acid blue 40, C.I. acid blue 324, FD&C yellow 6, C.I. direct yellow 11, C.I. direct yellow 44, C.I. direct yellow 107, C.I. direct yellow 119, C.I. direct yellow 127, C.I. direct yellow 131, C.I. direct yellow 147, C.I. direct yellow 154, C.I. direct orange 26, C.I. direct orange 118, C.I. direct red 81, C.I. direct red 239, C.I. direct violet 9, C.I. direct violet 35, C.I. direct blue 71, C.I. direct blue 86, C.I. direct blue 199, C.I. direct blue 218, C.I. direct blue 273, C.I. direct blue 279, C.I. direct blue 281, C.I. direct black 19, C.I. direct black 80, C.I. direct black 170, C.I. direct black 179, C.I. reactive orange 16, C.I. reactive orange 122, C.I. reactive red 120, or combinations thereof. Other water-soluble anionic dyes are also contemplated.

In many embodiments, the water-soluble fluorescent brighteners of the disclosed colorant composition comprise C.I. fluorescent brightener 113, C.I. fluorescent brightener 220, C.I. fluorescent brightener 264, C.I. fluorescent brightener 357, or combinations thereof.

In many embodiments, the water-soluble cationic dyes of the disclosed colorant composition comprise C.I. basic yellow 2, C.I. basic orange 2, C.I. basic red 12, C.I. basic violet 1, C.I. basic violet 3, C.I. basic green 4, C.I. basic blue 140, C.I. basic blue 152, C.I. basic blue 154, C.I. basic brown 1, or combinations thereof.

In many embodiments, the at least one colorant comprises about 10% by weight to about 50% by weight of the colorant composition. In some embodiments, the at least one colorant comprises about 15% by weight to about 45% by weight of the colorant composition. In another embodiment, the at least one colorant comprises about 20% by weight to about 40% by weight of the colorant composition.

Although not bound to theory, the colorant composition may contain the anionic dye as an insoluble particle wherein the electrolyte content of the colorant composition is adjusted to maintain the anionic dye as a particle and to meet the viscosity requirement of the composition. Adjustments to maintain the dye as a particle may be made by providing additional water, at least one water-soluble inorganic salt, at least one colorant, or combinations thereof. Further, adjusting a specific gravity of the colorant composition and/or adjusting a viscosity of the colorant composition, or combinations thereof may be made by providing additional water, at least one water-soluble inorganic salt, at least one colorant, or combinations thereof.

In many embodiments, the colorant composition described herein has certain storage stability characteristics. Stability, as described herein, refers to a substantially homogeneous composition in which there is no or minimized syneresis (defined as a layered liquid separation of the composition) and in which the colorant composition may remain liquid and stable at freezing temperatures (at or below 0° C.) or temperatures above room temperature (typically above 20° C.). In many embodiments, the colorant composition described herein may remain liquid and retains its stability characteristics after 2 months. In some embodiments, the colorant composition described herein may remain liquid and retains its stability characteristics after 3 months. In some embodiments, the colorant composition described herein may remain liquid and retains its stability characteristics after 6 months. In some embodiments, the colorant composition described herein may remain liquid and retains its stability characteristics after 9 months. In some embodiments, the colorant composition described herein may remain liquid and retains its stability characteristics after 12 months. In some embodiments, the colorant composition described herein may remain liquid and retains its stability characteristics after 18 months. In some embodiments, the colorant composition described herein may remain liquid and retains its stability characteristics after 18 months. Although stability characteristics may be retained by the colorant composition described herein, mixing, shaking, or stirring the colorant composition described herein may be desirable. Although not bound by theory, the colorant compositions described herein may not be adversely affected by sub-freezing temperatures due to the dyes present as particles, minimalizing crystallization. Further, the high salt content provided from the at least one water-soluble inorganic salt may aid to depress the freezing point of the colorant composition.

In many embodiments, the colorant composition described herein has a high color value. Whereas powder and granular forms may be marketed at 200% (twice the color value of the standard) or 100% (equal color value to the standard), the color values of typical liquid dye products may range from 25% to 67%. In many embodiments, the colorant composition described herein has a color value of at least 70%. In further embodiments, the colorant composition described has a color value of at least 75%, e.g., of at least 80%, of at least 85%, of at least 90%, of at least 100%, of at least 110%, of at least 125%, of at least 130%, of at least 140%, of at least 150%, of at least 175%, or of at least 180%. In many embodiments, the colorant composition described herein has a color value ranging from 70% to 150%. In further embodiments, the colorant composition described has a color value ranging from 75% to 140%, e.g. from 75% to 130%, from 75% to 120%, from 75% to 110%, from 75% to 100%, from 80% to 140%, from 80% to 130%, from 80% to 120%, from 80% to 110%, from 80% to 100%, from 90% to 140%, from 90% to 130%, from 90% to 120%, or from 90% to 110%.

In many embodiments, the colorant composition described herein is environmentally friendly and has a neutral environmental impact by using materials that do not require specialized waste streams. In many embodiments, the colorant composition described herein has minimal hygiene concerns in which dusting and known hazardous chemicals are minimized during processing. For example, it would be beneficial to minimize or eliminate any use of urea, triethylamine (TEA), and diethylamine (DEA). It would also be desirable if the colorant compositions have limited solvent content or are substantially solvent-free. In many embodiments, the colorant composition described herein is substantially solvent-free. In some embodiments, the colorant composition described herein is solvent-free. In many embodiments, the colorant composition described herein is substantially biocide-free. In some embodiments, the colorant composition described herein is biocide-free. In many embodiments, the colorant composition described herein is substantially mildewcide-free. In some embodiments, the colorant composition described herein is mildewcide-free. In many embodiments, the colorant composition described herein is substantially fungicide-free. In some embodiments, the colorant composition described herein is substantially fungicide-free. In many embodiments, the colorant composition is substantially free of at least one mildewcide, biocide, fungicide, or combinations thereof. Although not bound by theory, the high salt content of the colorant composition may preclude bacterial, mildew, and/or fungal growth so that addition of biocides, mildewcides, fungicides, or combinations thereof are not necessary. As such, the colorant composition described herein may be at least partially resistant to common bacteria, mildew, and fungi.

In many embodiments, the colorant composition described herein has ratings of at least 3 for the Global Harmonized System (GHS) for classifying hazardous chemicals. Further, in many embodiments, the colorant composition described herein is not explosive, flammable, corrosive, an oxidizer, an irritant, a toxic substance, and environmental hazard, or a health hazard as defined by GHS standard definitions.

In many embodiments, the colorant composition described herein may be substantially solvent free. In other embodiments, the colorant composition described herein may contain minimal solvents.

Although not wishing to be bound by theory, the colorant composition described herein may have thixotropic to pseudoplastic properties. Thus, under static conditions the colorant composition described herein may be thick and have a higher viscosity greater than about 2000 cP at 20° C. The viscosity of the colorant composition described herein is tested on a #3 spindle at 20 rpm after 10 minutes. However, when stress such as low shear mixing is applied the viscosity decreases to about 500 cP to about 2000 cP at 20° C. such that the composition is more fluid and may be more easily pumped and/or transferred through metering systems. Any pumping system known in the industry may be used for the colorant composition described herein. In one embodiment, peristaltic pumping systems may be used. In many embodiments, a viscosity of the colorant composition ranges from about 500 cP to about 2000 cP at 20° C. In some embodiments, the viscosity may be about 500 cP to about 1500 cP at 20° C. In another embodiment, the viscosity may be about 750 cP to about 2000 cP at 20° C. In yet another embodiment, the viscosity may be about 750 cP to about 1500 cP at 20° C.

In many embodiments, the colorant composition described herein has a particle size from the at least one colorant of about 100 μm to about 200 μm. In another embodiment, the particle size may be about 100 μm to about 150 μm.

In some embodiments, the colorant compositions described herein may be mixed upon application to produce hybrid colors, specialty shades, or specific target colors or shades.

In many embodiments, the colorant composition is a dye. In many embodiments, the dye is used to color textile, yarn, fiber, paper, leather, wood, plastic, ink, food, or combinations thereof. Other dye uses are also contemplated.

In some embodiments, the colorant composition described herein further comprises at least one defoaming agent, humectant, dispersant, surfactant, binder, biocide, fungicide, mildewcide, or combinations thereof. For any additives in the disclosed colorant composition, there should be no or minimal impacts to the performance properties. Further, any additives in the disclosed colorant composition should impart no toxicity or environmental hazards. Additionally, any additives in the disclosed colorant composition may have no or substantially no VOC's. Alternatively, any additives in the disclosed colorant composition may have minimal or low VOC's (defined as less than 1%). In many embodiments, the colorant composition described herein is substantially free of organic solvent. Organic solvents may include, but are not limited to aliphatic hydrocarbons, aromatic hydrocarbons, amines, esters, ethers, ketones, alcohols, and nitrated or chlorinated hydrocarbons, or combinations thereof. Common organic solvents may include, but are not limited to, acetone, benzene, butanol, ethanol, ethylene glycol, methanol, propanol, toluene, triethylamine, and xylene.

Also described herein is a method of preparing with the colorant composition described above.

Also described herein is a method of preparing a colorant composition, the method comprising: 1) preparing a mixture of water and microcrystalline cellulose, wherein the mixture comprises about 0.2% by weight to 5.0% by weight microcrystalline cellulose; 2) adding at least one water-soluble inorganic salt to the mixture of water and microcrystalline cellulose; and 3) adding at least one colorant comprising water-soluble anionic dyes, water-soluble fluorescent brighteners, water-soluble cationic dyes, or combinations thereof to the mixture of water, microcrystalline cellulose, and at least one water-soluble inorganic salt.

In many embodiments, the water in the disclosed method of preparing a colorant composition comprises about 30% by weight to about 75% by weight of the colorant composition. In other embodiments, the water may be about 40% by weight to about 70% by weight of the colorant composition. In another embodiment, the water may be about 45% by weight to about 65% by weight of the colorant composition.

In many embodiments, the at least one water-soluble inorganic salt in the method of preparing a colorant composition comprises lithium chloride, potassium chloride, sodium chloride, calcium chloride, or combinations thereof. In many embodiments, the water-soluble inorganic salt may be any alkali metal halide or alkaline earth metal halide that is compatible with the colorant composition and imparts no toxicity or environmental hazard. In many embodiments, halide salts may include, but are not limited to, fluorides, chlorides, bromides, iodides, and combinations thereof. In some embodiments, chlorides of the halide salts may comprise lithium chloride, sodium chloride, potassium chloride, calcium chloride, and combinations thereof. In many embodiments, the at least one water-soluble inorganic salt comprises about 5% by weight to about 27% by weight of the colorant composition. In some embodiments, the at least one water-soluble inorganic salt comprises about 5% by weight to about 25% by weight of the colorant composition. In other embodiments, the at least one water-soluble inorganic salt comprises about 10% by weight to about 25% by weight of the colorant composition. In still other embodiments, the at least one water-soluble inorganic salt comprises about 10% by weight to about 20% by weight of the colorant composition. In yet other embodiments, the at least one water-soluble inorganic salt comprises about 15% by weight to about 25% by weight of the colorant composition. Not to be bound by theory, the water-soluble inorganic salt and water mixture may aid in suspending at least one colorant within the colorant composition.

In many embodiments, the microcrystalline cellulose used in the method of preparing the colorant composition comprises about 0.2% by weight to about 5.0% by weight of the colorant composition. In other embodiments, the microcrystalline cellulose comprises about 0.5% by weight to about 5.0% by weight of the colorant composition. In some embodiments, the microcrystalline cellulose comprises about 1.0% by weight to about 5.0% by weight of the colorant composition. In another embodiment, the microcrystalline cellulose comprises about 1.0% by weight to about 4.0% by weight of the colorant composition. In yet another embodiment, the microcrystalline cellulose comprises about 1.0% by weight to about 3.0% by weight of the colorant composition. In still another embodiment, the microcrystalline cellulose comprises about 1.0% by weight to about 2.0% by weight of the colorant composition. Microcrystalline cellulose may be a refined wood pulp. Although not bound by theory, microcrystalline cellulose may form a three dimensional structural network or gel form to the colorant composition described herein due to its fibril structure forms. In many embodiments, microcrystalline cellulose has substantial compatibility with the colorant composition, particularly with the high electrolyte content of the colorant composition. In many embodiments, the microcrystalline cellulose may act as a thickening agent. Although not to be bound by theory, the combination of the high electrolyte content of the colorant composition and the thickening action of the microcrystalline cellulose may imparts thixotropic or pseudoplastic properties to the colorant composition wherein the high viscosity and specific gravity of the composition stabilizes the suspension of the dye particles. Due to this thixotropic or pseudoplastic nature of the composition, the colorant composition may become fluid when subjected to low sheer mixing and can be metered through a pumping system to the dye application unit.

In many embodiments, the at least one colorant of the method of preparing the colorant composition is an acid dye, a direct dye, a reactive dye, or combinations thereof. Water-soluble dyes anionic dyes may include any of acid, direct and reactive dyes as defined by the Colour Index™ from the Society of Dyers and Colorants. These dyes may contain functional groups that carry an active hydrogen that may be released under neutral and alkaline pH to form an anionic group that imparts at least some degree of water solubility to the dye. Such groups include but are not limited to sulfonic acids, carboxylic acids, phosphonic acids, and combinations thereof. As dyes are conventionally characterized in relation to a color strength standard, the water solubility may be defined as from 1 g/l to 250 g/l as 100% color equivalent to the standard.

In many embodiments, the water-soluble anionic dyes of the disclosed colorant composition comprise C.I. acid red 361, C.I. acid red 151, C.I. acid blue 40, C.I. acid blue 324, FD&C yellow 6, C.I. direct yellow 11, C.I. direct yellow 44, C.I. direct yellow 107, C.I. direct yellow 119, C.I. direct yellow 127, C.I. direct yellow 131, C.I. direct yellow 147, C.I. direct yellow 154, C.I. direct orange 26, C.I. direct orange 118, C.I. direct red 81, C.I. direct red 239, C.I. direct violet 9, C.I. direct violet 35, C.I. direct blue 71, C.I. direct blue 86, C.I. direct blue 199, C.I. direct blue 218, C.I. direct blue 273, C.I. direct blue 279, C.I. direct blue 281, C.I. direct black 19, C.I. direct black 80, C.I. direct black 170, C.I. direct black 179, C.I. reactive orange 16, C.I. reactive orange 122, C.I. reactive red 120, or combinations thereof. Other water-soluble anionic dyes are also contemplated.

In many embodiments, the water-soluble fluorescent brighteners of the disclosed colorant composition comprise C.I. fluorescent brightener 113, C.I. fluorescent brightener 220, C.I. fluorescent brightener 264, C.I. fluorescent brightener 357, or combinations thereof.

In many embodiments, the water-soluble cationic dyes of the disclosed colorant composition comprise C.I. basic yellow 2, C.I. basic orange 2, C.I. basic red 12, C.I. basic violet 1, C.I. basic violet 3, C.I. basic green 4, C.I. basic blue 140, C.I. basic blue 152, C.I. basic blue 154, C.I. basic brown 1, or combinations thereof.

In many embodiments, the at least one colorant in the method of preparing the colorant composition comprises about 10% by weight to about 50% by weight of the colorant composition. In some embodiments, the at least one colorant comprises about 15% by weight to about 45% by weight of the colorant composition. In another embodiment, the at least one colorant comprises about 20% by weight to about 40% by weight of the colorant composition.

In some embodiments, the method of preparing the colorant composition described herein may further comprise adjusting a specific gravity of the colorant composition, adjusting a viscosity of the colorant composition, adjusting a pH of the colorant composition, or combinations thereof by providing additional water, at least one water-soluble inorganic salt, at least one colorant, or combinations thereof. In some embodiments, the colorant composition described herein may further comprise adjusting a specific gravity of the colorant composition, adjusting a viscosity of the colorant composition, adjusting a pH of the colorant composition, or combinations thereof by adding at least one water-soluble inorganic salt, microcrystalline cellulose, or combinations thereof such that the particles of the colorant composition are at least partially homogeneously suspended and the aqueous phase of the slurry is substantially free of color. EXAMPLES

General Laboratory Method for Preparation of the Water-soluble Dye Composition: 50 g water was charged to a stainless steel beaker and under high speed mixing employing a Cowles Dissolver running at a tip linear velocity of 762 m/min, 1 g microcrystalline cellulose was added. This preparation was mixed for about 15 to 30 minutes. Then 10-15 grams of sodium chloride was added while mixing continued until all the salt was in solution. Next, with high speed mixing as defined previously 30 gr of a dye was added and the mixing continued until the viscosity reached 300-500 cP and the dye particles were ground to a particle size of from 100-200 micron. When the composition was spotted on filter paper, no color was observed in the runout. The composition was then standardized to a defined color strength with the addition of 5-10 g 20% salt solution containing 1.0-1.5% microcrystalline cellulose under high speed mixing as described above.

Example slurry preparation of a cationic blue dye for paper preparation:

In 1200 ml stainless steel beaker charge, add 154 g water and 0.5 highly refined mineral oil under high speed mixing. Add 1 g microcrystalline cellulose and mix for about 15 minutes. Charge 218 g cationic blue base press cake (CAS #68411-04-1, 48% solids) and mix with Cowles dissolver at liner speed of 365 m/minute (1200 feet/minute) for 30 minutes to achieve a particle size distribution peak of 100 μm to 200 μm. Then charge 80 g sodium chloride and mix until all salt is dissolved. Then charge 5 g sorbitol 70% and adjust pH to 3.0-3.1 using 18 g hydrochloric acid 32% under high-speed stirring. The strength may be adjusted, if necessary, using 24% sodium chloride solution containing 0.2% microcrystalline cellulose under high speed stirring.

Example colorant compositions described herein and obtained according to the method described herein are listed in the following Table 1.

| | | | | | WATER- | | | | |
|---|---|---|---|---|---|---|---|---|---|
| | | | | | SOLUBLE | | | | |
| | | MICRO- | | | INORGANIC | BASIC | DIRECT | DIRECT | DIRECT |
| | | CRYSTAL- | | | SALT | BROWN | BLACK | BLACK | BLUE |
| | | LINE | | SURFAC- | (SODIUM | 1 | 19 | 179 | 71 |
| PRODUCT | WATER | CELLULOSE | DEFOAMER | TANT | CHLORIDE) | CRUDE | CRUDE | CRUDE | CRUDE |
| BASIC BROWN | 51.40 | 1.00 | 0.10 | | 16.50 | 30.00 | | | |
| A SLIQUID | | | | | | | | | |
| DIRECT BLACK | 57.30 | 1.00 | 0.10 | | 15.60 | | 25.00 | | |
| A SLIQUID CONC | | | | | | | | | |
| DIRECT BLACK | 57.00 | 0.65 | 0.10 | | 17.50 | | | 23.75 | |
| B SLIQUID | | | | | | | | | |
| DIRECT BLUE | 68.08 | 1.00 | 0.10 | | 18.00 | | | | 11.82 |
| A SLIQUID | | | | | | | | | |
| DIRECT BLUE | 59.45 | 1.00 | 0.10 | | 18.00 | | | | 20.45 |
| B SLIQUID CONC | | | | | | | | | |
| DIRECT BLUE | 63.51 | 1.00 | 0.10 | | 10.00 | | | | |
| C SLIQUID | | | | | | | | | |
| DIRECT RED | 55.97 | 1.00 | 0.10 | | 16.60 | | | | |
| A SLIQUID | | | | | | | | | |
| DIRECT VIOLET | 56.54 | 0.75 | 0.10 | | 15.90 | | | | |
| A SLIQUID | | | | | | | | | |
| DIRECT YELLOW | 48.98 | 1.00 | 0.10 | | 16.78 | | | | |
| A SLIQUID | | | | | | | | | |
| DIRECT YELLOW | 47.00 | 1.00 | 0.10 | | 15.90 | | | | |
| B SLIQUID CONC | | | | | | | | | |
| DIRECT YELLOW | 66.47 | 1.00 | 0.10 | | 17.75 | | | | |
| C SLIQUID | | | | | | | | | |
| DIRECT YELLOW | 54.89 | 1.00 | 0.10 | | 17.75 | | | | |
| D SLIQUID | | | | | | | | | |
| REACTIVE ORANGE | 60.40 | 0.50 | | 0.10 | 12.00 | | | | |
| MIX A | | | | | | | | | |

| | DIRECT | DIRECT | DIRECT | DIRECT | DIRECT | DIRECT | REACTIVE | REACTIVE | | |
|---|---|---|---|---|---|---|---|---|---|---|
| | BLUE | VIOLET | RED | YELLOW | YELLOW | YELLOW | ORANGE | ORANGE | | |
| | 218 | 9 | 81 | 11 | 44 | 147 | 122 | 16 | HUMEC- | |
| PRODUCT | CRUDE | CRUDE | CRUDE | CRUDE | CRUDE | CRUDE | CRUDE | CRUDE | TANT | TOTAL |
| BASIC BROWN | | | | | | | | | 1.00 | 100.00 |
| A SLIQUID | | | | | | | | | | |
| DIRECT BLACK | | | | | | | | | 1.00 | 100.00 |
| A SLIQUID CONC | | | | | | | | | | |
| DIRECT BLACK | | | | | | | | | 1.00 | 100.00 |
| B SLIQUID | | | | | | | | | | |
| DIRECT BLUE | | | | | | | | | 1.00 | 100.00 |
| A SLIQUID | | | | | | | | | | |
| DIRECT BLUE | | | | | | | | | 1.00 | 100.00 |
| B SLIQUID CONC | | | | | | | | | | |
| DIRECT BLUE | 24.39 | | | | | | | | 1.00 | 100.00 |
| C SLIQUID | | | | | | | | | | |
| DIRECT RED | | | 25.33 | | | | | | 1.00 | 100.00 |
| A SLIQUID | | | | | | | | | | |
| DIRECT VIOLET | | 25.71 | | | | | | | 1.00 | 100.00 |
| A SLIQUID | | | | | | | | | | |
| DIRECT YELLOW | | | | 32.14 | | | | | 1.00 | 100.00 |
| A SLIQUID | | | | | | | | | | |
| DIRECT YELLOW | | | | | 35.00 | | | | 1.00 | 100.00 |
| B SLIQUID CONC | | | | | | | | | | |
| DIRECT YELLOW | | | | | | 13.68 | | | 1.00 | 100.00 |
| C SLIQUID | | | | | | | | | | |
| DIRECT YELLOW | | | | | | 25.26 | | | 1.00 | 100.00 |
| D SLIQUID | | | | | | | | | | |
| REACTIVE ORANGE | | | | | | | 12.00 | 14.00 | 1.00 | 100.00 |
| MIX A | | | | | | | | | | |

Further compositions are also contemplated.

### Embodiments

The following embodiments are contemplated. All combinations of features and embodiments are contemplated.

Embodiment 1: A colorant composition comprising: 1) water; 2) at least one water-soluble inorganic salt; 3) microcrystalline cellulose; and 4) at least one colorant comprising water-soluble anionic dyes, water-soluble fluorescent brighteners, water-soluble cationic dyes, or combinations thereof; wherein a weight ratio of the at least one water-soluble inorganic salt to the at least one colorant in the colorant composition ranges from 1:0.25 to 1:4.0; and wherein a specific gravity of the colorant composition is about 1.05 kg/l to about 1.45 kg/l.

Embodiment 2: An embodiment of embodiment 1, wherein the water comprises about 30% by weight to about 75% by weight of the colorant composition.

Embodiment 3: An embodiment of embodiment 1, wherein the at least one water-soluble inorganic salt comprises lithium chloride, potassium chloride, sodium chloride, calcium chloride, or combinations thereof.

Embodiment 4: An embodiment of embodiment 1, wherein the at least one water-soluble inorganic salt comprises about 5% by weight to about 27% by weight of the colorant composition.

Embodiment 5: An embodiment of embodiment 1, wherein the microcrystalline cellulose comprises about 0.2% by weight to about 5.0% by weight of the colorant composition.

Embodiment 6: An embodiment of embodiment 1, wherein the at least one colorant is an acid dye, a direct dye, a reactive dye, or combinations thereof.

Embodiment 7: An embodiment of embodiment 1, wherein the water-soluble anionic dyes comprise C.I. acid red 361, C.I. acid red 151, C.I. acid blue 40, C.I. acid blue 324, FD&C yellow 6, C.I. direct yellow 11, C.I. direct yellow 44, C.I. direct yellow 107, C.I. direct yellow 119, C.I. direct yellow 127, C.I. direct yellow 131, C.I. direct yellow 147, C.I. direct yellow 154, C.I. direct orange 26, C.I. direct orange 118, C.I. direct red 81, C.I. direct red 239, C.I. direct violet 9, C.I. direct violet 35, C.I. direct blue 71, C.I. direct blue 86, C.I. direct blue 199, C.I. direct blue 218, C.I. direct blue 273, C.I. direct blue 279, C.I. direct blue 281, C.I. direct black 19, C.I. direct black 80, C.I. direct black 170, C.I. direct black 179, C.I. reactive orange 16, C.I. reactive orange 122, C.I. reactive red 120, or combinations thereof.

Embodiment 8: An embodiment of embodiment 1, wherein the water-soluble fluorescent brighteners comprise C.I. fluorescent brightener 113, C.I. fluorescent brightener 220, C.I. fluorescent brightener 264, C.I. fluorescent brightener 357, or combinations thereof.

Embodiment 9: An embodiment of embodiment 1, wherein the water-soluble cationic dyes comprise C.I. basic yellow 2, C.I. basic orange 2, C.I. basic red 12, C.I. basic violet 1, C.I. basic violet 3, C.I. basic green 4, C.I. basic blue 140, C.I. basic blue 152, C.I. basic blue 154, C.I. basic brown 1, or combinations thereof.

Embodiment 10: An embodiment of embodiment 1, wherein the at least one colorant comprises about 10% by weight to about 50% by weight of the colorant composition.

Embodiment 11: An embodiment of embodiment 1, wherein a particle size from the at least one colorant is about 100 μm to about 200 μm.

Embodiment 12: An embodiment of embodiment 1, wherein a viscosity of the colorant composition ranges from about 500 cP to about 2000 cP at 20° C. on a #3 spindle at 20 rpm after 10 minutes.

Embodiment 13: An embodiment of embodiment 1, wherein the colorant composition is substantially free of an organic solvent.

Embodiment 14: An embodiment of embodiment 1, wherein the colorant composition is substantially free of at least one mildewcide, biocide, fungicide, or combinations thereof.

Embodiment 15: An embodiment of embodiment 1, wherein the colorant composition is a dye.

Embodiment 16: An embodiment of embodiment 15, wherein the dye is used to color textile, yarn, fiber, paper, leather, wood, plastic, ink, food, or combinations thereof.

Embodiment 17: An embodiment of embodiment 1, further comprising at least one defoaming agent, humectant, dispersant, surfactant, binder, biocide, fungicide, mildewcide, or combinations thereof.

Embodiment 18: A method of preparing with the colorant composition of embodiment 1.

Embodiment 19: A method of preparing a colorant composition, the method comprising: 1) preparing a mixture of water and microcrystalline cellulose, wherein the mixture comprises about 0.2% by weight to 5.0% by weight microcrystalline cellulose; 2) adding at least one water-soluble inorganic salt to the mixture of water and microcrystalline cellulose; and 3) adding at least one colorant comprising water-soluble anionic dyes, water-soluble fluorescent brighteners, water-soluble cationic dyes, or combinations thereof to the mixture of water, microcrystalline cellulose, and at least one water-soluble inorganic salt.

Embodiment 20: An embodiment of embodiment 19, further comprising adjusting a specific gravity of the colorant composition, adjusting a viscosity of the colorant composition, adjusting a pH of the colorant composition, or combinations thereof by providing additional water, at least one water-soluble inorganic salt, at least one colorant, or combinations thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

We claim:

1. A colorant composition comprising:
water;
at least one water-soluble inorganic salt;
microcrystalline cellulose; and
at least one colorant comprising water-soluble anionic dyes, water-soluble fluorescent brighteners, water-soluble cationic dyes, or combinations thereof;
wherein a weight ratio of the at least one water-soluble inorganic salt to the at least one colorant in the colorant composition ranges from 1:0.25 to 1:4.0; and
wherein a specific gravity of the colorant composition is about 1.05 kg/l to about 1.45 kg/l.

2. The colorant composition of claim 1, wherein the water comprises about 30% by weight to about 75% by weight of the colorant composition.

3. The colorant composition of claim 1, wherein the at least one water-soluble inorganic salt comprises lithium chloride, potassium chloride, sodium chloride, calcium chloride, or combinations thereof.

4. The colorant composition of claim 1, wherein the at least one water-soluble inorganic salt comprises about 5% by weight to about 27% by weight of the colorant composition.

5. The colorant composition of claim 1, wherein the microcrystalline cellulose comprises about 0.2% by weight to about 5.0% by weight of the colorant composition.

6. The colorant composition of claim 1, wherein the at least one colorant is an acid dye, a direct dye, a reactive dye, or combinations thereof.

7. The colorant composition of claim 1, wherein the water-soluble anionic dyes comprise C.I. acid red 361, C.I. acid red 151, C.I. acid blue 40, C.I. acid blue 324, FD&C yellow 6, C.I. direct yellow 11, C.I. direct yellow 44, C.I. direct yellow 107, C.I. direct yellow 119, C.I. direct yellow 127, C.I. direct yellow 131, C.I. direct yellow 147, C.I. direct yellow 154, C.I. direct orange 26, C.I. direct orange 118, C.I. direct red 81, C.I. direct red 239, C.I. direct violet 9, C.I. direct violet 35, C.I. direct blue 71, C.I. direct blue 86, C.I. direct blue 199, C.I. direct blue 218, C.I. direct blue 273, C.I. direct blue 279, C.I. direct blue 281, C.I. direct black 19, C.I. direct black 80, C.I. direct black 170, C.I. direct black 179, C.I. reactive orange 16, C.I. reactive orange 122, C.I. reactive red 120, or combinations thereof.

8. The colorant composition of claim 1, wherein the water-soluble fluorescent brighteners comprise C.I. fluorescent brightener 113, C.I. fluorescent brightener 220, C.I. fluorescent brightener 264, C.I. fluorescent brightener 357, or combinations thereof.

9. The colorant composition of claim 1, wherein the water-soluble cationic dyes comprise C.I. basic yellow 2, C.I. basic orange 2, C.I. basic red 12, C.I. basic violet 1, C.I. basic violet 3, C.I. basic green 4, C.I. basic blue 140, C.I. basic blue 152, C.I. basic blue 154, C.I. basic brown 1, or combinations thereof.

10. The colorant composition of claim 1, wherein the at least one colorant comprises about 10% by weight to about 50% by weight of the colorant composition.

11. The colorant composition of claim 1, wherein a particle size from the at least one colorant is about 100 μm to about 200 μm.

12. The colorant composition of claim 1, wherein a viscosity of the colorant composition ranges from about 500 cP to about 2000 cP at 20° C. on a #3 spindle at 20 rpm after 10 minutes.

13. The colorant composition of claim 1, wherein the colorant composition is substantially free of an organic solvent.

14. The colorant composition of claim 1, wherein the colorant composition is substantially free of at least one mildewcide, biocide, fungicide, or combinations thereof.

15. The colorant composition of claim 1, wherein the colorant composition is a dye.

16. The colorant composition of claim 15, wherein the dye is used to color textile, yarn, fiber, paper, leather, wood, plastic, ink, food, or combinations thereof.

17. The colorant composition of claim 1, further comprising at least one defoaming agent, humectant, dispersant, surfactant, binder, biocide, fungicide, mildewcide, or combinations thereof.

18. A method of preparing with the colorant composition of claim 1.

19. A method of preparing a colorant composition, the method comprising:
preparing a mixture of water and microcrystalline cellulose, wherein the mixture comprises about 0.2% by weight to 5.0% by weight microcrystalline cellulose;
adding at least one water-soluble inorganic salt to the mixture of water and microcrystalline cellulose; and
adding at least one colorant comprising water-soluble anionic dyes, water-soluble fluorescent brighteners, water-soluble cationic dyes, or combinations thereof to the mixture of water, microcrystalline cellulose, and at least one water-soluble inorganic salt.

20. The method of preparing a colorant composition of claim 19, further comprising adjusting a specific gravity of the colorant composition, adjusting a viscosity of the colorant composition, adjusting a pH of the colorant composition, or combinations thereof by providing additional water, at least one water-soluble inorganic salt, at least one colorant, or combinations thereof.
